(19) United States
(12) Patent Application Publication
(10) Pub. No.: US 2026/0255327 A1
(43) Pub. Date: Aug. 27, 2026

(54) CHANNEL OCCUPANCY TIME SHARING METHOD AND APPARATUS

(71) Applicant: Beijing Xiaomi Mobile Software Co., Ltd., Beijing (CN)

(72) Inventors: Wensu ZHAO, Beijing (CN); Qun ZHAO, Beijing (CN)

(73) Assignee: Beijing Xiaomi Mobile Software Co., Ltd., Beijing (CN)

(21) Appl. No.: 18/875,776

(22) PCT Filed: Jun. 30, 2022
(86) PCT No.: PCT/CN2022/103166

§ 371 Date: Dec. 17, 2024

(51) Int. Cl. H04W 72/0446; H04W 74/08

(52) U.S. Cl. CPC H04W 72/0446; H04W 74/08

(57) ABSTRACT

A channel occupancy time (COT) sharing method includes: a first terminal device sending COT time allocation indication information to a second terminal device, wherein the COT time allocation indication information is used for indicating a time, which is allocated to the second terminal device, in a COT; and the second terminal device sharing the COT, which is initiated by the first terminal device.

### CROSS-REFERENCE TO RELATED APPLICATIONS

The present application is a U.S. National Stage of International Application No. PCT/CN2022/103166, filed on Jun. 30, 2022, the disclosure of which is incorporated herein by reference in its entirety for all purposes.

### TECHNICAL FIELD

The present disclosure relates to the field of communication technology, and in particular to a channel occupancy time (COT) sharing method and apparatus.

### BACKGROUND

With the continuous emergence of new communication services and application requirements, terminal's sidelink (SL, also called direct link) communication has higher and higher requirements for performance such as transmission bandwidth, communication rate, communication delay, reliability, and scalability. Limited licensed spectrum alone cannot meet the diverse application scenarios and requirements in the future. At present, COT sharing is supported on the terminal's sidelink communication on the unlicensed spectrum (sidelink-unlicensed, SL-U), but there is no specific implementation of COT sharing.

### SUMMARY

The embodiments of the present disclosure provide a method and apparatus for sharing channel occupancy time, which can be applied to the field of communication technology to enable a first terminal device to send COT time allocation indication information to a second terminal device, where the COT time allocation indication information is used to indicate the time allocated to the second terminal device in the COT; the second terminal device shares the COT initiated by the first terminal device.

In a first aspect, an embodiment of the present disclosure provides a method for sharing channel occupancy time, which is performed by a first terminal device that initiates a channel occupancy time (COT), and the method includes: sending COT time allocation indication information to a second terminal device, where the COT time allocation indication information is used to indicate time allocated to the second terminal device in the COT; and the COT initiated by the first terminal device is shared by the second terminal device.

In a second aspect, an embodiment of the present disclosure provides another method for sharing channel occupancy time, which is performed by a second terminal device that shares the channel occupancy time (COT), and the method includes: receiving COT time allocation indication information from a first terminal device that initiates the COT, where the COT time allocation indication information is used to indicate time allocated to the second terminal device in the COT; and the second terminal device shares the COT initiated by the first terminal device.

In a third aspect, an embodiment of the present disclosure provides a first terminal device, which has some or all of the functions of the first terminal device in the method described in the first aspect above, for example, the functions of the first terminal device may have some or all of the functions in the embodiments of the present disclosure, or may have the functions of implementing any one of the embodiments of the present disclosure separately. The functions may be implemented by hardware, or by hardware executing corresponding software. The hardware or software includes one or more units or modules corresponding to the above functions.

In an implementation, the structure of the first terminal device may include a transceiving module and a processing module, and the processing module is configured to support the first terminal device to perform the corresponding functions in the above method. The transceiving module is configured to support communication between the first terminal device and other devices. The first terminal device may also include a storage module, which is configured to couple with the transceiving module and the processing module, and stores computer programs and data necessary for the first terminal device.

As an example, the processing module may be a processor, the transceiving module may be a transceiver or a communication interface, and the storage module may be a memory.

In a fourth aspect, an embodiment of the present disclosure provides a second terminal device, which has some or all of the functions of the second terminal device in the method example described in the second aspect above, for example, the functions of the second terminal device may have some or all of the functions in the embodiments of the present disclosure, or may have the functions of implementing any one of the embodiments of the present disclosure separately. The functions may be implemented by hardware, or by hardware executing corresponding software. The hardware or software includes one or more units or modules corresponding to the above functions.

In an implementation, the structure of the second terminal device may include a transceiving module and a processing module, and the processing module is configured to support the second terminal device to perform the corresponding functions in the above method. The transceiving module is configured to support communication between the second terminal device and other devices. The second terminal device may also include a storage module, which is configured to couple with the transceiving module and the processing module, and stores computer programs and data necessary for the second terminal device.

As an example, the processing module may be a processor, the transceiving module may be a transceiver or a communication interface, and the storage module may be a memory.

In a fifth aspect, an embodiment of the present disclosure provides a communication apparatus, which includes a processor, and when the processor calls a computer program in a memory, it performs the method described in the first aspect.

In a sixth aspect, an embodiment of the present disclosure provides a communication apparatus, which includes a processor, and when the processor calls a computer program in a memory, it performs the method described in the second aspect.

In the seventh aspect, an embodiment of the present disclosure provides a communication apparatus, which includes a processor and a memory in which a computer program is stored; the processor executes the computer program stored in the memory to cause the communication apparatus to perform the method described in the first aspect above.

In an eighth aspect, an embodiment of the present disclosure provides a communication device, which includes a processor and a memory in which a computer program is stored; the processor executes the computer program stored in the memory to cause the communication apparatus to perform the method described in the second aspect above.

In a ninth aspect, an embodiment of the present disclosure provides a communication apparatus, which includes a processor and an interface circuit, the interface circuit is configured to receive code instructions and transmit them to the processor, and the processor is configured to run the code instructions to cause the apparatus to perform the method described in the first aspect above.

In a tenth aspect, an embodiment of the present disclosure provides a communication apparatus, which includes a processor and an interface circuit, the interface circuit is configured to receive code instructions and transmit them to the processor, and the processor is configured to run the code instructions to cause the apparatus to perform the method described in the second aspect above.

In an eleventh aspect, an embodiment of the present disclosure provides a communication system, which includes the first terminal device described in the third aspect and the second terminal device described in the fourth aspect, or the system includes the communication apparatus described in the fifth aspect and the communication apparatus described in the sixth aspect, or the system includes the communication apparatus described in the seventh aspect and the communication apparatus described in the eighth aspect, or the system includes the communication apparatus described in the ninth aspect and the communication apparatus described in the tenth aspect.

In a twelfth aspect, an embodiment of the present invention provides a computer-readable storage medium for storing instructions for the above-mentioned first terminal device, and the instructions when being executed, cause the terminal device to perform the method described in the first aspect.

In a thirteenth aspect, an embodiment of the present invention provides a readable storage medium for storing instructions for the above-mentioned second terminal device, and the instructions when being executed, cause the network device to perform the method described in the above-mentioned second aspect.

In a fourteenth aspect, the present disclosure also provides a computer program product comprising a computer program which, when being executed on a computer, cause the computer to perform the method described in the first aspect above.

In a fifteenth aspect, the present disclosure also provides a computer program product comprising a computer program which, when being executed on a computer, cause the computer to perform the method described in the second aspect above.

In a sixteenth aspect, the present disclosure provides a chip system, which includes at least one processor and an interface, and is configured to support a first terminal device to implement the functions involved in the first aspect, for example, determining or processing at least one of the data and information involved in the above method. In a possible design, the chip system also includes a memory, and the memory is configured to store computer programs and data necessary for the first terminal device. The chip system can be composed of a chip, or it can include a chip and other discrete devices.

In a seventeenth aspect, the present disclosure provides a chip system, which includes at least one processor and an interface, and is configured to support the second terminal device to implement the functions involved in the second aspect, for example, determining or processing at least one of the data and information involved in the above method. In a possible design, the chip system also includes a memory, and the memory is configured to store computer programs and data necessary for the second terminal device. The chip system can be composed of a chip, or it can include a chip and other discrete devices.

In an eighteenth aspect, the present disclosure provides a computer program which, when being executed on a computer, cause the computer to perform the method described in the first aspect above.

In a nineteenth aspect, the present disclosure provides a computer program which, when being executed on a computer, cause the computer to perform the method described in the second aspect above.

### BRIEF DESCRIPTION OF THE DRAWINGS

In order to more clearly illustrate the technical solutions in the embodiments of the present disclosure or the background technology, the drawings required for use in the embodiments of the present disclosure or the background technology will be described below.

FIG. 1 is a schematic diagram of an architecture of a communication system provided in an embodiment of the present disclosure;

FIG. 2 is a schematic flow chart of a method for sharing channel occupancy time provided in an embodiment of the present disclosure;

FIG. 3 is a flow chart of another method for sharing channel occupancy time provided in an embodiment of the present disclosure;

FIG. 4 is a flow chart of another method for sharing channel occupancy time provided in an embodiment of the present disclosure;

FIG. 5 is a schematic flow chart of another method for sharing channel occupancy time provided in an embodiment of the present disclosure;

FIG. 6 is a flow chart of another method for sharing channel occupancy time provided in an embodiment of the present disclosure;

FIG. 7 is a schematic flow chart of another method for sharing channel occupancy time provided in an embodiment of the present disclosure;

FIG. 8 is a flow chart of another method for sharing channel occupancy time provided in an embodiment of the present disclosure;

FIG. 9 is a flow chart of another method for sharing channel occupancy time provided in an embodiment of the present disclosure;

FIG. 10 is a schematic diagram of a first allocation of COT in a case where the number of second terminal devices is single;

FIG. 11 is a schematic diagram of a first allocation of COT in a case where the number of second terminal devices is multiple;

FIG. 12 is a schematic diagram of a second allocation of COT in a case where the number of second terminal devices is single;

FIG. 13 is a schematic diagram of a second allocation of COT in a case where the number of second terminal devices is multiple;

FIG. 14 is a structural schematic diagram of a first terminal device provided in an embodiment of the present disclosure;

FIG. 15 is a structural schematic diagram of a second terminal device provided in an embodiment of the present disclosure;

FIG. 16 is a structural schematic diagram of a communication apparatus provided in an embodiment of the present disclosure; and

FIG. 17 is a structural schematic diagram of a chip provided in an embodiment of the present disclosure.

### DETAILED DESCRIPTION

The embodiments of the present disclosure are described in detail below, and examples of the embodiments are shown in the accompanying drawings, where the same or similar reference numerals throughout represent the same or similar elements or elements having the same or similar functions. The embodiments described below with reference to the accompanying drawings are exemplary and are intended to be used to explain the present disclosure, and should not be construed as limitations on the present disclosure. In the description of the present disclosure, unless otherwise specified, “/” means or, for example, A/B can mean A or B; “and/or” used herein is merely a description of the association relationship of associated objects, indicating that three relationships may exist, for example, A and/or B can mean: A exists alone, A and B exist at the same time, and B exists alone.

In order to better understand a method for sharing channel occupancy time disclosed in the embodiments of the present disclosure, a communication system to which the embodiments of the present disclosure are applicable is first described below.

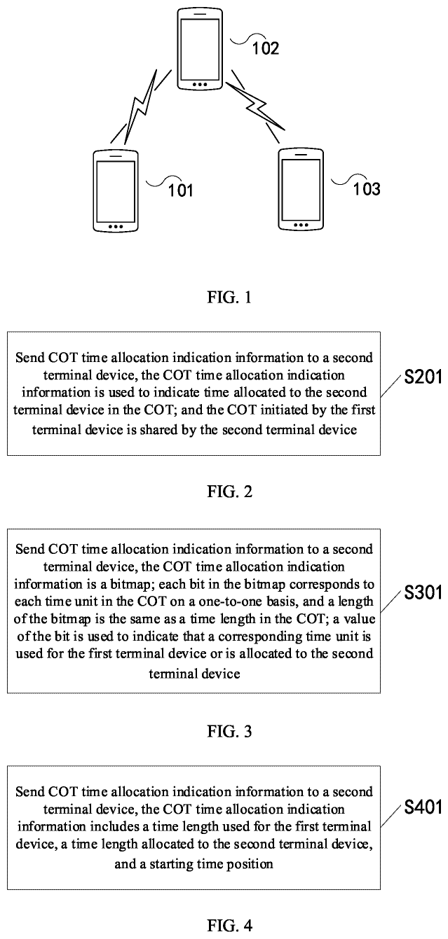

Please refer to FIG. 1, which is a schematic diagram of an architecture of a communication system provided in an embodiment of the present disclosure. The communication system may include but is not limited to three terminal devices, where the terminal devices communicate with each other via sidelink. The number and form of devices shown in FIG. 1 are only used as an example and do not constitute a limitation on the embodiments of the present disclosure. The communication system shown in FIG. 1 includes a first terminal device 101, a second terminal device 102, and a third terminal device 103 as an example.

In an embodiment of the present disclosure, the first terminal device 101, the second terminal device 102 and the third terminal device 103 can be each an entity for receiving or transmitting signals, such as a mobile phone. The terminal device can also be called a terminal, a user equipment (UE), a mobile station (MS), a mobile terminal (MT), etc. The terminal device can be a car with communication function, a smart car, a mobile phone, a wearable device, a Pad, a computer with wireless transceiving function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc. There is no limitation on the specific technology and specific device form employed for the terminal device in the embodiments of the present disclosure.

It can be understood that the communication system described in the embodiments of the present disclosure is for the purpose of more clearly illustrating the technical solution of the embodiments of the present disclosure, and does not constitute a limitation on the technical solution provided in the embodiments of the present disclosure. Those of ordinary skill in the art can understand that with the evolution of the system architecture and the emergence of new business scenarios, the technical solution provided in the embodiments of the present disclosure is also applicable to similar technical problems.

With the continuous emergence of new communication services and application requirements, the terminal sidelink (SL, also called direct link) communication has higher and higher requirements for transmission bandwidth, communication rate, communication delay, reliability, scalability and other performance. The limited licensed spectrum alone cannot meet the diverse application scenarios and requirements in the future. At present, the terminal sidelink communication on the unlicensed spectrum (sidelink-unlicensed, SL-U) supports channel occupancy time (COT) sharing, but there is no specific implementation of COT sharing. Therefore, it is necessary to determine the specific implementation of COT sharing.

The method and apparatus for sharing channel occupancy time provided by the present disclosure are described in detail below in conjunction with the accompanying drawings.

Please refer to FIG. 2, which is a flow chart of a method for sharing channel occupancy time provided in an embodiment of the present disclosure. It should be noted that the method for sharing channel occupancy time in the embodiment of the present disclosure is performed by a first terminal device, and the first terminal device is a terminal device that initiates COT. As shown in FIG. 2, the method for sharing channel occupancy time may include but is not limited to the following steps.

Step S201, COT time allocation indication information is sent to a second terminal device, where the COT time allocation indication information is used to indicate time allocated to the second terminal device in the COT; and the COT initiated by the first terminal device is shared by the second terminal device.

In some embodiments of the present disclosure, the number of the second terminal devices may be single. The single second terminal device may communicate with the first terminal device, or the single second terminal device may not communicate with the first terminal device. In the case where the single second terminal device communicates with the first terminal device, the single second terminal device may communicate with the first terminal device in unicast, or the single second terminal device may communicate with the first terminal device in multicast or in other ways.

In some other embodiments, the number of the second terminal devices may be multiple, and each of the multiple second terminal devices may communicate with the first terminal device, or may not communicate with the first terminal device.

In an embodiment of the present disclosure, in the COT time allocation indication information, a sum of a time length used for the first terminal device and a time length allocated to the second terminal device is the same as the time length in the COT, thereby ensuring continuous transmission over the entire COT.

In some embodiments, the COT may be divided into time units, that is, the COT may include multiple time units. The time length refers to the number of time units. In some embodiments, the time unit may be a slot, that is, one time unit represents one slot. In some other embodiments, the time unit may be a mini slot, that is, one time unit represents one mini slot.

For example, the number of the second terminal device is single and the COT includes N slots, in the COT time allocation indication information, the time length for the first terminal device is N1, and the time length allocated to the single second terminal device is N2; the sum of N1 and N2 is equal to N.

For example, there are multiple second terminal devices, and the COT includes N slots. The first terminal device is UE1, and the multiple second terminal devices include: UE2 and UE3. In the COT time allocation indication information, the time length used for UE1 is N1, the time length allocated to UE2 is N2, and the time length allocated to UE3 is N3; the sum of N1, N2 and N3 is equal to N.

In the embodiments of the present disclosure, in the case where the number of the second terminal device is single or multiple, in some embodiments, the first terminal device and the second terminal device may not support continuous transmission in multiple time units, the time length used for the first terminal device may be a single time unit, and the time length allocated to the second terminal device may be a single time unit. In some other embodiments, the first terminal device and the second terminal device may support continuous transmission in multiple time units, the time length used for the first terminal device is a single or multiple time units, and the time length allocated to the second terminal device is a single or multiple time units. In other words, the time length used for the first terminal device and the time length allocated to the second terminal device may be the same or different; the time lengths allocated to different second terminal devices may be the same or different.

In the embodiments of the present disclosure, in the case where the number of second terminal devices is single, in some embodiments, the COT time allocation indication information can be carried in any one of the following information and sent to the second terminal device: first-stage Sidelink Control Information (SCI), second-stage SCI information, Radio Resource Control (RRC) information, and Media Access Control Control Element (MAC CE) information.

In some other embodiments, the COT time allocation indication information may be sent by the first terminal device to the second terminal device in a first time period of the COT. The first time period may be a starting time unit of the COT, that is, the first time unit in the COT, which is the first slot of the COT, or the first mini slot of the COT.

In the embodiments of the present disclosure, in the case where there are multiple second terminal devices, the COT time allocation indication information can be sent by the first terminal device to the second terminal device in the first time period of the COT. The first time period can be the starting time unit of the COT, that is, the first time unit in the COT, which is the first slot of the COT, or the first mini slot of the COT.

According to the method for sharing channel occupancy time in the embodiment of the present disclosure, the first terminal device sends COT time allocation indication information to the second terminal device, and the COT time allocation indication information is used to indicate the time allocated to the second terminal device in the COT; the second terminal device shares the COT initiated by the first terminal device, so that the second terminal device can share the COT initiated by the first terminal device according to the COT time allocation indication information, thereby realizing COT sharing among multiple terminal devices, improving resource utilization, and meeting communication service needs.

It should be noted that the possible implementations described above can be performed separately or in combination, which is not limited in the embodiments of the present disclosure.

Please refer to FIG. 3, which is a flow chart of another method for sharing channel occupancy time provided in an embodiment of the present disclosure. It should be noted that the method for sharing channel occupancy time in the embodiment of the present disclosure can be performed by a first terminal device, which is the terminal device that initiates COT.

The method for sharing channel occupancy time can be performed alone, or can be performed in combination with any embodiment or a possible implementation in the embodiment in the present disclosure, or can be performed in combination with any technical solution in the related art.

As shown in FIG. 3, the method for sharing channel occupancy time may include but is not limited to the following steps.

Step S301, COT time allocation indication information is sent to a second terminal device, where the COT time allocation indication information is a bitmap; each bit in the bitmap corresponds to each time unit in the COT on a one-to-one basis, and a length of the bitmap is the same as a time length in the COT; a value of the bit is used to indicate that a corresponding time unit is used for the first terminal device or is allocated to the second terminal device.

In some embodiments, the COT may be divided into time units, that is, the COT may include multiple time units. The time length refers to the number of time units. In some embodiments, the time unit may be a slot, that is, one time unit represents one slot. In some other embodiments, the time unit may be a mini slot, that is, one time unit represents one mini slot.

In an embodiment of the present disclosure, the number of second terminal devices may be single. The single second terminal device may communicate with the first terminal device, or the single second terminal device may not communicate with the first terminal device. In the case where the single second terminal device communicates with the first terminal device, the single second terminal device may communicate with the first terminal device by unicast, or the single second terminal device may communicate with the first terminal device by multicast or in other ways.

In an embodiment of the present disclosure, the value of each bit in the bitmap may be 0 or 1. In some embodiments, for each bit in the bitmap, when the value of the bit is 0, it is used to indicate that the corresponding time unit is used for the first terminal device; and when the value of the bit is 1, it is used to indicate that the corresponding time unit is allocated to the second terminal device.

In some other embodiments, for each bit in the bitmap, when the value of the bit is 0, it is used to indicate that the corresponding time unit is allocated to the second terminal device; and when the value of the bit is 1, it is used to indicate that the corresponding time unit is used for the first terminal device. For example, the COT includes 6 time units, and the bitmap includes 6 bits, for example, 111000, which is used to indicate that the first three time units in the COT are used for the first terminal device, and the last three time units in the COT are allocated to the second terminal device.

In the method for sharing channel occupancy time of the embodiment of the present disclosure, the first terminal device sends COT time allocation indication information to the second terminal device, and the COT time allocation indication information is a bitmap; each bit in the bitmap corresponds to each time unit in the COT on a one-to-one basis, and the length of the bitmap is the same as the time length in the COT; the value of the bit is used to indicate that the corresponding time unit is used for the first terminal device or is allocated to the second terminal device, so that the second terminal device can share the COT initiated by the first terminal device according to the COT time allocation indication information, thereby realizing COT sharing among multiple terminal devices, improving resource utilization, and meeting communication service needs.

Please refer to FIG. 4, which is a flow chart of another method for sharing channel occupancy time provided in an embodiment of the present disclosure. It should be noted that the method for sharing channel occupancy time in the embodiment of the present disclosure can be performed by a first terminal device, which is the terminal device that initiates COT.

The method for sharing channel occupancy time can be performed alone, or can be performed in combination with any embodiment or a possible implementation in the embodiment in the present disclosure, or it can be performed in combination with any technical solution in the related art.

As shown in FIG. 4, the method for sharing channel occupancy time may include but is not limited to the following steps.

Step S401, COT time allocation indication information is sent to a second terminal device, where the COT time allocation indication information includes: a time length used for the first terminal device, a time length allocated to the second terminal device, and a starting time position.

In an embodiment of the present disclosure, in the COT time allocation indication information, the sum of the time length used for the first terminal device and the time length allocated to the second terminal device is the same as the time length in the COT, thereby ensuring continuous transmission over the entire COT.

In an embodiment of the present disclosure, the COT may be divided into time units, that is, the COT may include multiple time units. The time length refers to the number of time units. In some embodiments, the time unit may be a slot, that is, one time unit represents one slot. In some other embodiments, the time unit may be a mini slot, that is, one time unit represents one mini slot. That is, one time unit represents one bit.

In an embodiment of the present disclosure, the starting time position for the first terminal device is a position of a starting time unit in the COT, which may not be indicated. For the second terminal device, in some embodiments, the starting time position allocated to the second terminal device may be represented by a serial number of the time unit in the COT. In some other embodiments, the starting time position allocated to the second terminal device may be represented by an offset of the time unit in the COT relative to the starting time unit in the COT.

In the embodiments of the present disclosure, in some embodiments, the number of second terminal devices may be single. The single second terminal device may communicate with the first terminal device, or the single second terminal device may not communicate with the first terminal device. In some other embodiments, the number of second terminal devices may be multiple. Each second terminal device in the multiple second terminal devices may communicate with the first terminal device, or may not communicate with the first terminal device.

In the method for sharing channel occupancy time of the embodiment of the present disclosure, the first terminal device sends COT time allocation indication information to the second terminal device, and the COT time allocation indication information includes: the time length used for the first terminal device, the time length allocated to the second terminal device, and the starting time position, where in the COT time allocation indication information, the sum of the time length used for the first terminal device and the time length allocated to the second terminal device is the same as the time length in the COT; so that the second terminal device can share the COT initiated by the first terminal device according to the COT time allocation indication information, realizing COT sharing among multiple terminal devices, improving resource utilization, and meeting communication service needs.

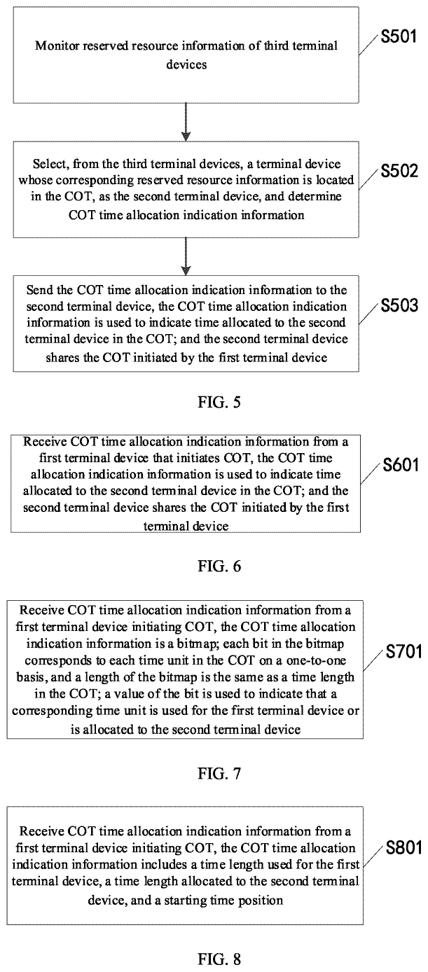

Please refer to FIG. 5, which is a flow chart of another method for sharing channel occupancy time provided in an embodiment of the present disclosure. It should be noted that the method for sharing channel occupancy time in the embodiment of the present disclosure can be performed by a first terminal device, which is the terminal device that initiates COT.

The method for sharing channel occupancy time can be performed alone, or can be performed in combination with any embodiment or a possible implementation method in the embodiment in the present disclosure, or it can be performed in combination with any technical solution in the related art.

As shown in FIG. 5, the method for sharing channel occupancy time may include but is not limited to the following steps.

Step S501, reserved resource information of third terminal devices is monitored.

In an embodiment of the present disclosure, the third terminal device may be any terminal device except the first terminal device. The number of the third terminal devices may be multiple. The third terminal device may communicate with the first terminal device, or may not communicate with the first terminal device.

In an embodiment of the present disclosure, the first terminal device can monitor the third terminal devices and obtain first-stage SCI information of the third terminal devices; and decode the first-stage SCI information to obtain the reserved resource information and identification of the third terminal device.

Step S502, a terminal device whose corresponding reserved resource information is located in the COT is selected from the third terminal devices as a second terminal device, and COT time allocation indication information is determined.

The first terminal device can determine the time that needs to be allocated to the second terminal device in the COT based on the reserved resource information of the second terminal device; and then determine the COT time allocation indication information based on the time that needs to be allocated to the second terminal device in the COT.

Step S503, the COT time allocation indication information is sent to the second terminal device, where the COT time allocation indication information is used to indicate the time allocated to the second terminal device in the COT; and the second terminal device shares the COT initiated by the first terminal device.

For a detailed description of step S503, reference may be made to the corresponding description of this step in the above embodiments, which will not be described in detail here.

In the method for sharing channel occupancy time of the embodiment of the present disclosure, the first terminal device monitors the reserved resource information of the third terminal devices; selects from the third terminal devices a terminal device whose corresponding reserved resource information is located in the COT as the second terminal device, and determines the COT time allocation indication information; and sends the COT time allocation indication information to the second terminal device, where the COT time allocation indication information is used to indicate the time allocated to the second terminal device in the COT; the second terminal device shares the COT initiated by the first terminal device, so that the second terminal device can share the COT initiated by the first terminal device according to the COT time allocation indication information, thereby realizing COT sharing among multiple terminal devices, improving resource utilization, and meeting communication service needs.

Please refer to FIG. 6, which is a flow chart of another method for sharing channel occupancy time provided in an embodiment of the present disclosure. It should be noted that the method for sharing channel occupancy time in the embodiment of the present disclosure can be performed by a second terminal device, and the second terminal device is a terminal device that shares the channel occupancy time COT. As shown in FIG. 6, the method for sharing channel occupancy time may include but is not limited to the following steps.

Step S601, COT time allocation indication information is received from a first terminal device that initiates a COT, where the COT time allocation indication information is used to indicate time allocated to the second terminal device in the COT; and the second terminal device shares the COT initiated by the first terminal device.

In some embodiments of the present disclosure, the number of the second terminal devices may be single. The single second terminal device may communicate with the first terminal device, or the single second terminal device may not communicate with the first terminal device. In the case where the single second terminal device communicates with the first terminal device, the single second terminal device may communicate with the first terminal device in unicast, or the single second terminal device may communicate with the first terminal device in multicast or in other ways.

In some other embodiments, the number of the second terminal devices may be multiple, and each of the multiple second terminal devices may communicate with the first terminal device, or may not communicate with the first terminal device.

In an embodiment of the present disclosure, in the COT time allocation indication information, a sum of a time length used for the first terminal device and a time length allocated to the second terminal device is the same as the time length in the COT, thereby ensuring continuous transmission over the entire COT.

In some embodiments, the COT may be divided into time units, that is, the COT may include multiple time units. The time length refers to the number of the time units. In some embodiments, the time unit may be a slot, that is, one time unit represents one slot. In some other embodiments, the time unit may be a mini slot, that is, one time unit represents one mini slot. That is, one time unit represents one bit.

For example, the number of the second terminal devices is single and the COT includes N slots. In the COT time allocation indication information, the time length for the first terminal device is N1, and the time length allocated to the single second terminal device is N2; the sum of N1 and N2 is equal to N.

For example, the number of the second terminal devices is multiple and the COT includes N slots. The first terminal device is UE1, and the multiple second terminal devices include: UE2 and UE3. In the COT time allocation indication information, the time length used for UE1 is N1, the time length allocated to UE2 is N2, and the time length allocated to UE3 is N3; the sum of N1, N2 and N3 is equal to N.

In the embodiments of the present disclosure, in the case where the number of the second terminal devices is single or multiple, in some embodiments, the first terminal device and the second terminal device may not support continuous transmission in multiple time units, the time length used for the first terminal device may be a single time unit, and the time length allocated to the second terminal device may be a single time unit. In some other embodiments, the first terminal device and the second terminal device may support continuous transmission in multiple time units, the time length used for the first terminal device is a single or multiple time units, and the time length allocated to the second terminal device is a single or multiple time units. In other words, the time length used for the first terminal device and the time length allocated to the second terminal device may be the same or different; the time lengths allocated to different second terminal devices may be the same or different.

In the embodiments of the present disclosure, in the case where the number of the second terminal devices is single, in some embodiments, the COT time allocation indication information can be carried in any one of the following information and sent to the second terminal device: first-stage SCI information, second-stage SCI information, RRC information and MAC CE information.

In some other embodiments, the process of performing step S601 by the second terminal device may be, for example, to receive the COT time allocation indication information sent by the first terminal device in a first time period of the COT; the first time period is a starting time unit of the COT, that is, the first slot of the COT, or the first mini slot of the COT.

In an embodiment of the present disclosure, in the case where the number of the second terminal devices is multiple, the process of performing step S601 by the second terminal device may be, for example, to receive the COT time allocation indication information sent by the first terminal device in the first time period of the COT; the first time period is the starting time unit of the COT, that is, the first slot of the COT, or the first mini slot of the COT.

In the method for sharing channel occupancy time of the embodiment of the present disclosure, the second terminal device receives the COT time allocation indication information of the first terminal device initiating the COT, and the COT time allocation indication information is used to indicate the time allocated to the second terminal device in the COT; the second terminal device shares the COT initiated by the first terminal device, so that the second terminal device can share the COT initiated by the first terminal device according to the COT time allocation indication information, thereby realizing COT sharing among multiple terminal devices, improving resource utilization, and meeting communication service needs.

It should be noted that the possible implementations described above can be performed separately or in combination, which is not limited in the embodiments of the present disclosure.

Please refer to FIG. 7, which is a flow chart of another method for sharing channel occupation time provided in an embodiment of the present disclosure. It should be noted that the method for sharing channel occupation time in the embodiment of the present disclosure can be performed by a second terminal device, and the second terminal device is a terminal device that shares the channel occupation time COT.

The method for sharing channel occupation time can be performed alone, or can be performed in combination with any embodiment or a possible implementation method in the embodiment in the present disclosure, or it can be performed in combination with any technical solution in the related art.

As shown in FIG. 7, the method for sharing channel occupation time may include but is not limited to the following steps.

Step S701, COT time allocation indication information is received from a first terminal device initiating the COT, where the COT time allocation indication information is a bitmap; each bit in the bitmap corresponds to each time unit in the COT on a one-to-one basis, and a length of the bitmap is the same as a time length in the COT; a value of the bit is used to indicate that a corresponding time unit is used for the first terminal device or is allocated to the second terminal device.

In some embodiments, the COT may be divided into time units, that is, the COT may include multiple time units. The time length refers to the number of the time units. In some embodiments, the time unit may be a slot, that is, one time unit represents one slot. In some other embodiments, the time unit may be a mini slot, that is, one time unit represents one mini slot. That is, one time unit represents one bit.

In an embodiment of the present disclosure, the number of the second terminal devices may be single. The single second terminal device may communicate with the first terminal device, or the single second terminal device may not communicate with the first terminal device. In the case where the single second terminal device communicates with the first terminal device, the single second terminal device may communicate with the first terminal device by unicast, or the single second terminal device may communicate with the first terminal device by multicast or in other ways.

In an embodiment of the present disclosure, the value of each bit in the bitmap may be 0 or 1. In some embodiments, for each bit in the bitmap, when the value of the bit is 0, it is used to indicate that the corresponding time unit is used for the first terminal device; and when the value of the bit is 1, it is used to indicate that the corresponding time unit is allocated to the second terminal device.

In some other embodiments, for each bit in the bitmap, when the value of the bit is 0, it is used to indicate that the corresponding time unit is allocated to the second terminal device; and when the value of the bit is 1, it is used to indicate that the corresponding time unit is used for the first terminal device. For example, the COT includes six time units, and the bitmap includes six bits, for example, 111000, which is used to indicate that the first three time units in the COT are used for the first terminal device, and the last three time units in the COT are allocated to the second terminal device.

In the method for sharing channel occupancy time of the embodiment of the present disclosure, the second terminal device receives the COT time allocation indication information of the first terminal device initiating the COT, the COT time allocation indication information is a bitmap; each bit in the bitmap corresponds to each time unit in the COT on a one-to-one basis, and the length of the bitmap is the same as the time length in the COT; the value of the bit is used to indicate that the corresponding time unit is used for the first terminal device or is allocated to the second terminal device, so that the second terminal device can share the COT initiated by the first terminal device according to the COT time allocation indication information, thereby realizing COT sharing among multiple terminal devices, improving resource utilization, and meeting communication service needs.

Please refer to FIG. 8, which is a flow chart of another method for sharing channel occupation time provided in an embodiment of the present disclosure. It should be noted that the method for sharing channel occupation time in the embodiment of the present disclosure can be performed by a second terminal device, and the second terminal device is a terminal device that shares the channel occupation time COT.

The method for sharing channel occupation time can be performed alone, or can be performed in combination with any embodiment or a possible implementation method in the embodiment in the present disclosure, or it can be performed in combination with any technical solution in the related art.

As shown in FIG. 8, the method for sharing channel occupation time may include but is not limited to the following steps.

Step S801, COT time allocation indication information is received from a first terminal device initiating COT, where the COT time allocation indication information includes: a time length used for the first terminal device, a time length allocated to the second terminal device, and a starting time position.

In an embodiment of the present disclosure, in the COT time allocation indication information, a sum of a time length used for the first terminal device and a time length allocated to the second terminal device is the same as the time length in the COT, thereby ensuring continuous transmission over the entire COT.

In an embodiment of the present disclosure, the COT may be divided into time units, that is, the COT may include multiple time units. The time length refers to the number of the time units. In some embodiments, the time unit may be a slot, that is, one time unit represents one slot. In some other embodiments, the time unit may be a mini slot, that is, one time unit represents one mini slot. That is, one time unit represents one bit.

In an embodiment of the present disclosure, the starting time position for the first terminal device is the position of the starting time unit in the COT, which may not be indicated. For the second terminal device, in some embodiments, the starting time position allocated to the second terminal device may be represented by a serial number of the time unit in the COT. In some other embodiments, the starting time position allocated to the second terminal device may be represented by an offset of the time unit in the COT relative to the starting time unit in the COT.

In the embodiments of the present disclosure, in some embodiments, the number of the second terminal devices may be single. The single second terminal device may communicate with the first terminal device, or the single second terminal device may not communicate with the first terminal device. In some other embodiments, the number of the second terminal devices may be multiple. Each second terminal device in the multiple second terminal devices may communicate with the first terminal device, or may not communicate with the first terminal device.

In the method for sharing channel occupancy time of the embodiments of the present disclosure, the second terminal device receives the COT time allocation indication information of the first terminal device initiating the COT, and the COT time allocation indication information includes: the time length used for the first terminal device, the time length allocated to the second terminal device, and the starting time position, where in the COT time allocation indication information, the sum of the time length used for the first terminal device and the time length allocated to the second terminal device is the same as the time length in the COT; so that the second terminal device can share the COT initiated by the first terminal device according to the COT time allocation indication information, thereby realizing COT sharing among multiple terminal devices, improving resource utilization, and meeting communication service needs.

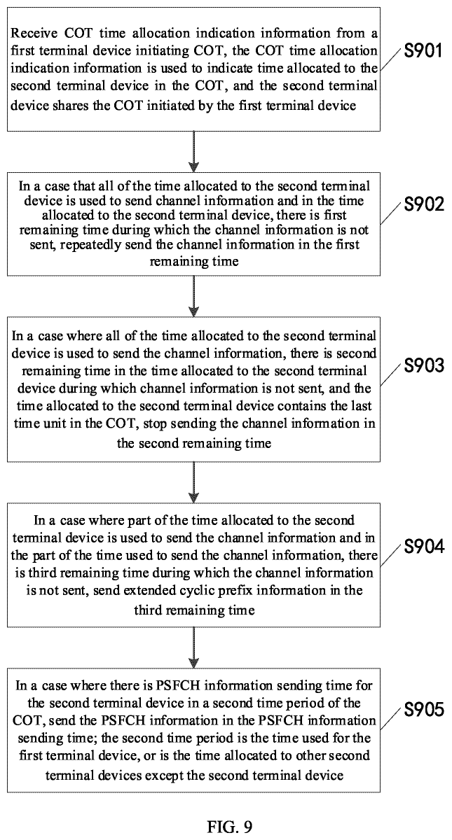

Please refer to FIG. 9, which is a flow chart of another method for sharing channel occupation time provided in an embodiment of the present disclosure. It should be noted that the method for sharing channel occupation time in the embodiment of the present disclosure can be performed by a second terminal device, and the second terminal device is a terminal device that shares the channel occupation time COT.

The method for sharing channel occupation time can be performed alone, or can be performed in combination with any embodiment or a possible implementation method in the embodiment in the present disclosure, or it can be performed in combination with any technical solution in the related art.

As shown in FIG. 9, the method for sharing channel occupation time may include but is not limited to the following steps.

Step S901, COT time allocation indication information from a first terminal device initiating COT is received, where the COT time allocation indication information is used to indicate time allocated to the second terminal device in the COT, and the second terminal device shares the COT initiated by the first terminal device.

For the detailed description of step S901, reference may be made to the corresponding description of this step in the above embodiments, which will not be described in detail here.

Step S902, in a case that all of the time allocated to the second terminal device is used to send channel information and in the time allocated to the second terminal device, there is first remaining time during which the channel information is not sent, the channel information is repeatedly sent in the first remaining time.

In an embodiment of the present disclosure, all of the time allocated to the second terminal device is used to send the channel information, which may mean that the time allocated to the second terminal device is all used to send the channel information and is not used to send other information. The channel information may include at least one of the following: Physical Sidelink Control Channel (PSCCH) information, Physical Sidelink Shared Channel (PSSCH) information, and Physical Sidelink Feedback Channel (PSFCH) information.

The first remaining time during which the channel information is not sent in the time allocated to the second terminal device means that the length of the time allocated to the second terminal device is greater than the length of the time during which the second terminal device sends the channel information. When the length of the time allocated to the second terminal device is equal to the length of the time during which the second terminal device sends the channel information, there is no first remaining time during which the channel information is not sent, that is, there is no remaining time. The channel information that is repeatedly sent may be, for example, PSCCH information and/or PSSCH information.

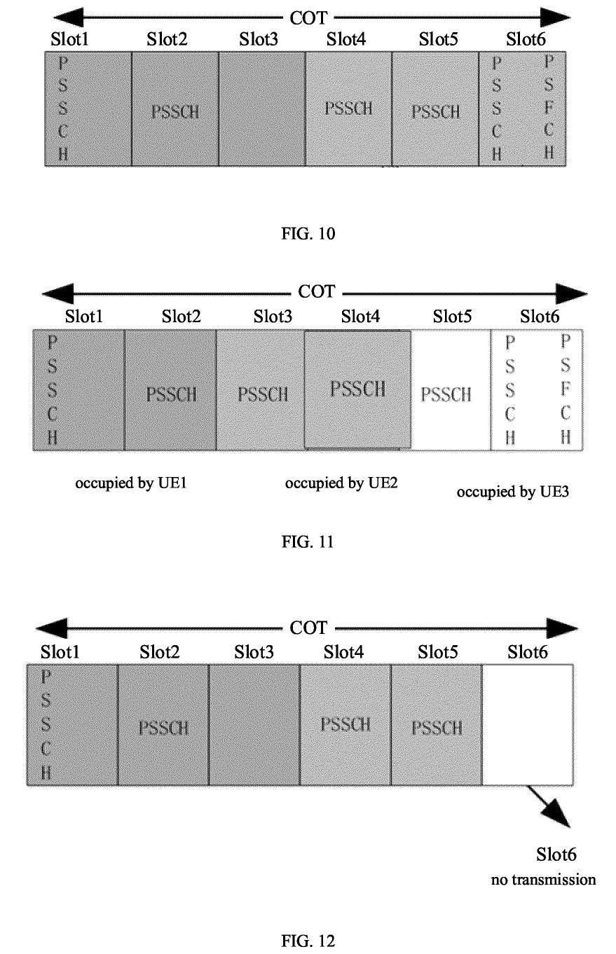

As shown in FIG. 10, it is a schematic diagram of a first allocation of the COT in the case where the number of the second terminal devices is only one. In FIG. 10, the number of the time units, i.e., slots, in the COT is 6, namely slot 1, slot 2, slot3, slot4, slot5, and slot6. Slot1 to slot3 are used for the first terminal device, and slot4 to slot6 are allocated to the second terminal device.

Among slot4 to slot6 allocated to the second terminal device, the second terminal device can use slots 4 to 5 to complete transmission of the channel information, and the second terminal device can repeat the transmission of the channel information in slot 6. In addition, when there is PSFCH information transmission time for the first terminal device in slot 6, the first terminal device can also send PSFCH information in slot 6.

As shown in FIG. 11, it is a schematic diagram of a first allocation of COT in the case where the number of the second terminal devices is multiple. In FIG. 11, the number of the time units, i.e., slots, in the COT is 6, namely slot 1, slot 2, slot3, slot4, slot5, and slot6. Slot1 to slot2 are used for the first terminal device (for example, UE1); slot3 to slot4 are allocated to a second terminal device (for example, UE2); and slot5 to slot6 are allocated to another second terminal device (for example, UE3).

Among the slots 5 to 6 allocated to UE3, UE3 can use slot 5 to complete the transmission of the channel information, and UE3 can repeat the transmission of the channel information in slot 6. In addition, when there is PSFCH information transmission time for another terminal device in slot 6, the other terminal device can also send the PSFCH information in slot 6. For example, the other terminal device may be UE1 or UE2.

Step S903, in a case where all of the time allocated to the second terminal device is used to send the channel information, there is second remaining time in the time allocated to the second terminal device during which channel information is not sent, and the time allocated to the second terminal device contains the last time unit in the COT, transmission of the channel information is stopped in the second remaining time.

As shown in FIG. 12, it is a schematic diagram of a second allocation of COT in the case where the number of the second terminal devices is only one. In FIG. 12, the number of the time units, i.e., slots, in the COT is 6, namely slot 1, slot 2, slot3, slot4, slot5, and slot6. Slot1 to slot3 are used for the first terminal device, and slot4 to slot6 are allocated to the second terminal device.

Among slot4 to slot6 allocated to the second terminal device, the second terminal device can use slot4 to slot5 to complete transmission of the channel information. When slot6 is the last time unit, that is, the last slot, in the COT, the second terminal device can stop transmission of the channel information in slot6.

Step S904, in a case where part of the time allocated to the second terminal device is used to send the channel information and in the part of the time used to send the channel information, there is third remaining time during which the channel information is not sent, extended cyclic prefix information is sent in the third remaining time.

Step S905, in a case where there is PSFCH information sending time for the second terminal device in a second time period of the COT, the PSFCH information is sent in the PSFCH information sending time; where the second time period is the time used for the first terminal device, or is the time allocated to other second terminal devices except the second terminal device.

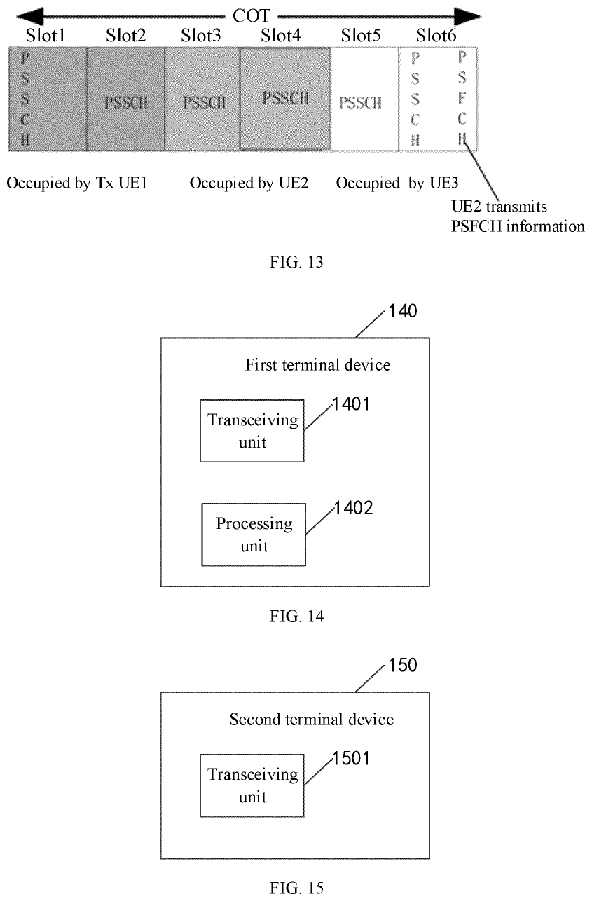

As shown in FIG. 13, it is a schematic diagram of a second allocation of COT in the case where the number of the second terminal devices is multiple. In FIG. 13, the number of the time units, i.e., slots, in the COT is 6, namely slot 1, slot 2, slot3, slot4, slot5, and slot6. Slot1 to slot2 are used for the first terminal device (for example, UE1); slot3 to slot4 are allocated to a second terminal device (for example, UE2); and slot5 to slot6 are allocated to another second terminal device (for example, UE3).

Among slot5 to slot6 allocated to UE3, there is PSFCH information sending time for UE2 in slot 6, and UE2 can reuse the PSFCH information sending time in slot 6 to send the PSFCH information.

It should be noted that each step in the above step S902 to step S905 is a separate step, that is, only one or more of the steps can be performed. There is no sequence order or association between the steps, and they can be performed independently.

In the method for sharing channel occupancy time of the embodiments of the present disclosure, the second terminal device receives the COT time allocation indication information from the first terminal device initiating the COT, and the COT time allocation indication information is used to indicate the time allocated to the second terminal device in the COT; the second terminal device shares the COT initiated by the first terminal device; when there is remaining time in the allocated time, it selects to repeatedly send channel information, stop sending the channel information or send extended cyclic prefix information, depending on the situation; when the PSFCH information sending time is located in the time allocated to other terminal devices, the time is reused to send the PSFCH information, thereby realizing COT sharing among multiple terminal devices, improving resource utilization, and meeting communication service needs.

In the above embodiments provided by the present disclosure, the methods provided by the embodiments of the present disclosure are introduced from the perspectives of the first terminal device and the second terminal device, respectively. In order to implement the functions in the methods provided by the above embodiments of the present disclosure, the first terminal device and the second terminal device may include a hardware structure and a software module, and implement the above functions in the form of a hardware structure, a software module, or a hardware structure plus a software module. A certain function of the above functions may be carried out in the form of the hardware structure, the software module, or the hardware structure plus the software module.

Please refer to FIG. 14, which is a structural schematic diagram of a first terminal device 140 provided in an embodiment of the present disclosure. The first terminal device is a terminal device that initiates COT.

The first terminal device 140 shown in FIG. 14 includes a transceiving unit 1401, which is configured to send COT time allocation indication information to a second terminal device, where the COT time allocation indication information is used to indicate time allocated to the second terminal device in the COT; and the COT initiated by the first terminal device is shared by the second terminal device.

In an implementation, in the COT time allocation indication information, a sum of a time length used for the first terminal device and a time length allocated to the second terminal device is the same as the time length in the COT.

In an implementation, the number of the second terminal devices is single.

In an implementation, the COT time allocation indication information is carried by any one of the following information: first-stage sidelink control information (SCI), second-stage SCI information, radio resource control (RRC) information, and media access control control element (MAC CE) information.

In an implementation, the number of the second terminal devices is multiple.

In an implementation, the transceiving unit 1401 is specifically configured to send the COT time allocation indication information to the second terminal device in a first time period of the COT; where the first time period is a starting time unit of the COT, that is, the first slot of the COT, or the first mini slot of the COT.

In an implementation, the COT time allocation indication information is a bitmap; each bit in the bitmap corresponds to each time unit in the COT on a one-to-one basis, and a length of the bitmap is the same as a time length in the COT; a value of the bit is used to indicate that a corresponding time unit is used for the first terminal device or is allocated to the second terminal device.

In an implementation, the COT time allocation indication information includes: a time length used for the first terminal device, a time length allocated to the second terminal device, and a starting time position.

In an implementation, the first terminal device and the second terminal device do not support continuous transmission in multiple time units, and the time length used for the first terminal device and the time length allocated to the second terminal device are each a single time unit; or, the first terminal device and the second terminal device support continuous transmission in multiple time units, and the time length used for the first terminal device is a single or multiple time units, and the time length allocated to the second terminal device is a single or multiple time units.

In an implementation, the first terminal device also includes: a processing unit 1402, which is configured to monitor reserved resource information of third terminal devices; select, from the third terminal devices, a terminal device whose corresponding reserved resource information is located within the COT, as the second terminal device, and determine the COT time allocation indication information.

Please refer to FIG. 15, which is a structural schematic diagram of a second terminal device 150 provided in an embodiment of the present disclosure. The second terminal device is a terminal device that shares a channel occupation time (COT), and the second terminal device 150 includes: a transceiving unit 1501, which receives COT time allocation indication information of a first terminal device that initiates the COT, where the COT time allocation indication information is used to indicate time allocated to the second terminal device in the COT, and the second terminal device shares the COT initiated by the first terminal device.

In an implementation, in the COT time allocation indication information, a sum of a time length used for the first terminal device and a time length allocated to the second terminal device is the same as a time length in the COT.

In an implementation, the number of the second terminal devices is single.

In an implementation, the COT time allocation indication information is carried by any one of the following information: first-stage sidelink control information (SCI), second-stage SCI information, radio resource control (RRC) information, and media access control control element (MAC CE) information.

In an implementation, the number of the second terminal devices is multiple.

In an implementation, the transceiving unit 1501 is specifically configured to receive the COT time allocation indication information sent by the first terminal device in a first time period of the COT, and the first time period is a starting time unit of the COT, that is, the first slot of the COT, or the first mini slot of the COT.

In an implementation, the COT time allocation indication information is a bitmap; where each bit in the bitmap corresponds to each time unit in the COT on a one-to-one basis, a length of the bitmap is the same as the time length in the COT, and a value of the bit is used to indicate that a corresponding time unit is used for the first terminal device or is allocated to the second terminal device.

In an implementation, the COT time allocation indication information includes: a time length used for the first terminal device, a time length allocated to the second terminal device, and a starting time position.

In an implementation, the first terminal device and the second terminal device do not support continuous transmission in multiple time units, and the time length used for the first terminal device and the time length allocated to the second terminal device are each a single time unit; or, the first terminal device and the second terminal device support continuous transmission in multiple time units, the time length used for the first terminal device is a single or multiple time units, and the time length allocated to the second terminal device is a single or multiple time units.

In an implementation, all or part of the time allocated to the second terminal device in the COT is used to send channel information; where the channel information includes at least one of the following: physical sidelink control channel (PSCCH) information, physical sidelink shared channel (PSSCH) information and physical sidelink feedback channel (PSFCH) information.

In an implementation, all of the time allocated to the second terminal device is used to send the channel information, and the transceiving unit 1501 is further configured to repeatedly send the channel information in first remaining time when there is the first remaining time in the time allocated to the second terminal device during which the channel information is not sent; or to stop sending the channel information in second remaining time when there is the second remaining time in the time allocated to the second terminal device during which the channel information is not sent and the time allocated to the second terminal device includes the last time unit in the COT.

In an implementation, part of the time allocated to the second terminal device is used to send the channel information, and the transceiving unit 1501 is further configured to send extended cyclic prefix information in third remaining time when there is the third remaining time in the part of the time used to send the channel information during which the channel information is not sent.

In an implementation, the transceiving unit 1501 is also configured to send PSFCH information in PSFCH information sending time when there is the PSFCH information sending time for the second terminal device in a second time period of the COT; where the second time period is the time used for the first terminal device, or is a slot allocated to other second terminal devices other than the second terminal device.

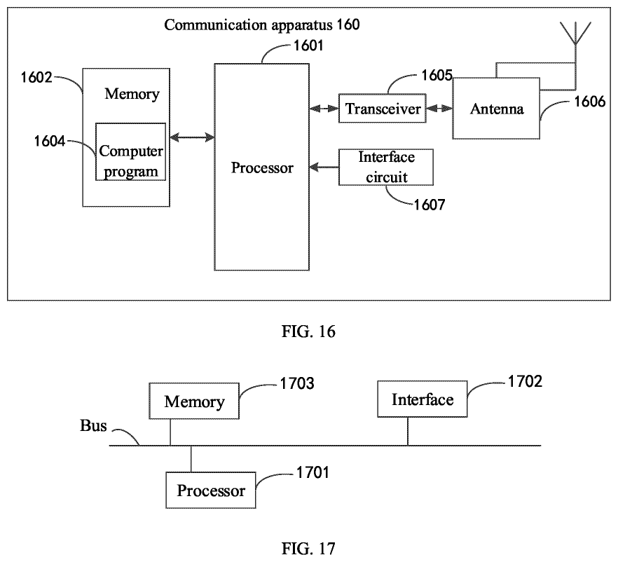

Please refer to FIG. 16, which is a structural schematic diagram of a communication apparatus 160 provided in an embodiment of the present disclosure. The communication apparatus 160 can be a terminal device (such as the first terminal device or the second terminal device in the aforementioned method embodiments), or can be a chip, a chip system, or a processor that supports the terminal device to implement the aforementioned methods. The apparatus can be configured to implement the methods described in the aforementioned method embodiments, and for details, reference can be made to the description in the aforementioned method embodiments.

The communication apparatus 160 may include one or more processors 1601. The processor 1601 may be a general-purpose processor, a dedicated processor, or the like. For example, it may be a baseband processor or a central processing unit. The baseband processor may be configured to process the communication protocol and communication data, and the central processing unit may be configured to control the communication apparatus (such as a base station, a baseband chip, a terminal device, a terminal device chip, a DU or a CU, etc.), execute a computer program, and process the data of the computer program.

In some embodiments, the communication apparatus 160 may further include one or more memories 1602, on which a computer program 1604 may be stored, and the processor 1601 executes the computer program 1604, to cause the communication apparatus 160 to perform the methods described in the above method embodiments. In some embodiments, data may also be stored in the memory 1602. The communication apparatus 160 and the memory 1602 may be provided separately or integrated together.

In some embodiments, the communication apparatus 160 may further include a transceiver 1605 and an antenna 1606. The transceiver 1605 may be referred to as a transceiving unit, a transceiver, a transceiver circuit, or the like, and is configured to implement the transceiving function. The transceiver 1605 may include a receiver and a transmitter, the receiver may be referred to as a receiving machine, a receiving circuit, or the like, and is configured to implement the receiving function; the transmitter may be referred to as a transmitting machine, a transmitting circuit, or the like, and is configured to implement the transmitting function.

In some embodiments, the communication apparatus 160 may further include one or more interface circuits 1607. The interface circuit 1607 is configured to receive code instructions and transmit them to the processor 1601. The processor 1601 runs the code instructions to cause the communication apparatus 160 to perform the methods described in the above method embodiments.

The communication apparatus 160 is the first terminal device, the transceiver 1605 is configured to perform step S201 in FIG. 2; step S301 in FIG. 3; step S401 in FIG. 4; and step S503 in FIG. 5. The processor 1601 is configured to perform step S501 and step S502 in FIG. 5.

The communication apparatus 160 is the second terminal device, the transceiver 1605 is configured to perform step S601 in FIG. 6; step S701 in FIG. 7; step S801 in FIG. 8; and steps S901, S902, S903, S904 and S905 in FIG. 9.

In an implementation, the processor 1601 may include a transceiver for implementing the receiving and transmitting functions. For example, the transceiver may be a transceiver circuit, an interface, or an interface circuit. The transceiver circuits, interfaces, or interface circuits used for implementing the receiving and transmitting functions may be separate or integrated. The above-mentioned transceiver circuit, interface, or interface circuit may be configured to read and write code/data, or the above-mentioned transceiver circuit, interface, or interface circuit may be configured to transmit or deliver signals.

In an implementation, the processor 1601 may store a computer program 1604 which, when running on the processor 1601, causes the communication apparatus 160 to perform the methods described in the above method embodiments. The computer program 1604 may be fixed in the processor 1601, in which case the processor 1601 may be implemented by hardware.

In an implementation, the communication apparatus 160 may include a circuit that can implement the functions of sending or receiving or communicating in the aforementioned method embodiments. The processor and transceiver described in the present disclosure can be implemented in an integrated circuit (IC), an analog IC, a radio frequency integrated circuit (RFIC), a mixed signal IC, an application specific integrated circuit (ASIC), a printed circuit board (PCB), an electronic device, etc. The processor and transceiver can also be manufactured using various IC process technologies, such as complementary metal oxide semiconductor (CMOS), N metal oxide semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication apparatus described in the above embodiments may be a network device or a terminal device (such as the first terminal device in the aforementioned method embodiment), but the scope of the communication apparatus described in the present disclosure is not limited thereto, and the structure of the communication apparatus may not be limited by FIG. 16. The communication apparatus may be an independent device or may be part of a larger device. For example, the communication apparatus may be:
(1) an independent integrated circuit IC, or chip, or chip system or subsystem;
(2) a collection of one or more ICs, and in some embodiments, including a storage component for storing data and computer programs;
(3) ASIC, such as modem;
(4) a module that can be embedded in other devices;
(5) a receiver, a terminal device, an intelligent terminal device, a cellular phone, a wireless device, a handheld device, a mobile unit, a vehicle-mounted device, a network device, a cloud device, an artificial intelligence device, etc.; or
(6) Others.

In the case where the communication apparatus can be a chip or a chip system, reference can be made to the structural schematic diagram of the chip shown in FIG. 17. The chip shown in FIG. 17 includes a processor 1701 and an interface 1702. The number of processors 1701 can be one or more, and the number of interfaces 1702 can be multiple.

In some embodiments, the chip further includes a memory 1703, and the memory 1703 is configured to store necessary computer programs and data.

Those skilled in the art can also understand that the various illustrative logical blocks and steps listed in the embodiments of the present disclosure may be implemented by electronic hardware, computer software, or a combination of the two. Whether such functions are implemented by hardware or software depends on the specific application and the design requirements of the entire system. Those skilled in the art may use various methods to implement the functions described for each specific application, but such implementation should not be understood as going beyond the protection scope of the embodiments of the present disclosure.

An embodiment of the present disclosure also provides a communication system, which includes the first terminal device in the above embodiment of FIG. 14, or includes the second terminal device in the above embodiment of FIG. 15.

The present disclosure also provides a readable storage medium having stored thereon instructions which, when being executed by a computer, implement the functions of any of the above method embodiments.

The present disclosure also provides a computer program product which, when being executed by a computer, implement the functions of any of the above method embodiments.

In the above embodiments, it can be implemented in whole or in part by software, hardware, firmware or any combination thereof. When implemented using software, it can be implemented in whole or in part in the form of a computer program product. The computer program product includes one or more computer programs. When the computer program is loaded and executed on a computer, the process or function described in the embodiments of the present disclosure is generated in whole or in part. The computer may be a general-purpose computer, a special-purpose computer, a computer network, or other programmable device. The computer program may be stored in a computer-readable storage medium, or transmitted from one computer-readable storage medium to another computer-readable storage medium. For example, the computer program may be transmitted from a website site, computer, server or data center to another website site, computer, server or data center by wired (e.g., a coaxial cable, an optical fiber, or a digital subscriber line (DSL)) or wireless (e.g., infrared, wireless, microwave, etc.) mode. The computer-readable storage medium may be any available medium that a computer can access or a data storage device such as a server or data center that includes one or more available media integrated. The available medium may be a magnetic medium (e.g., a floppy disk, a hard disk, a magnetic tape), an optical medium (e.g., a compact digital video disc (DVD)), a semiconductor medium (e.g., a solid state disk (SSD)), or the like.

Those of ordinary skill in the art can understand that the various numerical numbers such as first and second involved in the present disclosure are only used for the convenience of description and are not used to limit the scope of the embodiments of the present disclosure or indicate the order.

The “at least one” in the present disclosure can also be described as one or multiple, and multiple can be two, three, four or more, which is not limited in the present disclosure. In the embodiments of the present disclosure, for a certain kind of technical feature, technical features in this kind of technical features are distinguished by “first”, “second”, “third”, “A”, “B”, “C” and “D”, etc., and there is no order of precedence or size between the technical features described by the “first”, “second”, “third”, “A”, “B”, “C” and “D”.

The corresponding relationships shown in the tables in the present disclosure can be configured or predefined. The values of the information in each table are only examples and can be configured as other values, which are not limited in the present disclosure. When configuring the corresponding relationship between the information and the parameters, it is not necessarily required to configure all the corresponding relationships illustrated in each table. For example, in the table in the present disclosure, the corresponding relationships shown in some rows may not be configured. For another example, appropriate variations and adjustments can be made based on the above tables, such as splitting, merging, etc. The names of the parameters shown in the titles of the above tables can also use other names that can be understood by the communication apparatus, and the values or representations of the parameters can also be other values or representations that can be understood by the communication apparatus. When implementing the above tables, other data structures can also be used, such as arrays, queues, containers, stacks, linear lists, pointers, linked lists, trees, graphs, structures, classes, heaps, or hash tables.

The “predefined” in the present disclosure may be understood as defined, defined in advance, stored, pre-stored, pre-negotiated, pre-configured, solidified, or pre-burned.

Those of ordinary skill in the art will appreciate that the units and algorithm steps of examples described in conjunction with the embodiments disclosed herein can be implemented in electronic hardware, or a combination of computer software and electronic hardware. Whether these functions are performed in hardware or software depends on the specific application and design constraints of the technical solution. Professional and technical personnel can use different methods to implement the described functions for each specific application, and such implementations should not be considered as going beyond the scope of the present disclosure.

Those skilled in the art can clearly understand that, for the convenience and brevity of description, for the specific operation processes of the systems, apparatuses and units described above, reference can be made to the corresponding processes in the aforementioned method embodiments, which will not be repeated here.

The above are only specific implementations of the present disclosure, but the protection scope of the present disclosure is not limited thereto. Any person skilled in the art who is familiar with the present technical field can easily think of changes or substitutions within the technical scope disclosed in the present disclosure, which should be covered by the protection scope of the present disclosure. Therefore, the protection scope of the present disclosure should subject to the protection scope of the claims.

1. A method for sharing channel occupation time, the method being performed by a first terminal device that initiates channel occupation time (COT), and the method comprising:
sending COT time allocation indication information to a second terminal device, wherein the COT time allocation indication information is used to indicate time allocated to the second terminal device in the COT, and the COT initiated by the first terminal device is shared by the second terminal device.

2. The method according to claim 1, wherein in the COT time allocation indication information, a sum of a time length used for the first terminal device and a time length allocated to the second terminal device is the same as a time length of the COT.

3. The method according to claim 2, wherein the number of the second terminal device is one, and
wherein the COT time allocation indication information is carried by any one of the following information:
first-stage sidelink control information (SCI), second-stage SCI information, radio resource control (RRC) information and media access control control element (MAC CE) information.

4. (canceled)

5. The method according to claim 2, wherein the number of the second terminal devices is multiple, and
wherein the sending the COT time allocation indication information to the second terminal device comprises:
sending the COT time allocation indication information to the second terminal device in a first time period of the COT, wherein the first time period is a starting time unit of the COT.

6. (canceled)

7. The method according to claim 2, wherein the number of the second terminal device is one, and the COT time allocation indication information is a bitmap;
each bit in the bitmap corresponds to each time unit in the COT on a one-to-one basis, and a length of the bitmap is the same as the time length of the COT;
a value of the bit is used to indicate that a corresponding time unit is used for the first terminal device or is allocated to the second terminal device.

8. The method according to claim 2, wherein the number of the second terminal device is one or multiple, and the COT time allocation indication information comprises a time length used for the first terminal device, a time length allocated to the second terminal device, and a starting time position.

9. The method according to claim 8, wherein the first terminal device and the second terminal device do not support continuous transmission in multiple time units, the time length used for the first terminal device and the time length allocated to the second terminal device are each a single time unit; or
the first terminal device and the second terminal device support continuous transmission in multiple time units, the time length used for the first terminal device is a single or multiple time units, and the time length allocated to the second terminal device is a single or multiple time units.

10. The method according to claim 1, wherein the method further comprises:
monitoring reserved resource information of third terminal devices; and
selecting, from the third terminal devices, a terminal device whose corresponding reserved resource information is located within the COT, as the second terminal device, and determining the COT time allocation indication information.

11. A method for sharing a channel occupation time, the method being performed by a second terminal device that shares channel occupation time (COT), and the method comprising:
receiving COT time allocation indication information of a first terminal device that initiates the COT, wherein the COT time allocation indication information is used to indicate time allocated to the second terminal device in the COT, and the second terminal device shares the COT initiated by the first terminal device.

12. The method according to claim 11, wherein in the COT time allocation indication information, a sum of a time length used for the first terminal device and a time length allocated to the second terminal device is the same as a time length of the COT.

13. The method according to claim 12, wherein the number of the second terminal device is one, and
wherein the COT time allocation indication information is carried by any one of the following information:
first-stage sidelink control information (SCI), second-stage SCI information, radio resource control (RRC) information and media access control control element (MAC CE) information.

14. (canceled)

15. The method according to claim 12, wherein the number of the second terminal devices is multiple, and
wherein the receiving the COT time allocation indication information of the first terminal device that initiates the COT comprises:
receiving the COT time allocation indication information sent by the first terminal device in a first time period of the COT, wherein the first time period is a starting time unit of the COT.

16. (canceled)

17. The method according to claim 12, wherein the number of the second terminal device is one, and the COT time allocation indication information is a bitmap;
each bit in the bitmap corresponds to each time unit in the COT on a one-to-one basis, and a length of the bitmap is the same as the time length of the COT;
a value of the bit is used to indicate that a corresponding time unit is used for the first terminal device or is allocated to the second terminal device.

18. The method according to claim 12, wherein the number of the second terminal device is one or multiple, and the COT time allocation indication information comprises a time length used for the first terminal device, a time length allocated to the second terminal device, and a starting time position,
wherein the first terminal device and the second terminal device do not support continuous transmission in multiple time units, and the time length used for the first terminal device and the time length allocated to the second terminal device are each a single time unit; or
the first terminal device and the second terminal device support continuous transmission in multiple time units, the time length used for the first terminal device is a single or multiple time units, and the time length allocated to the second terminal device is a single or multiple time units.

19. (canceled)

20. The method according to claim 11, wherein all or part of the time allocated to the second terminal device in the COT is used to send channel information; and
the channel information comprises at least one of the following: physical sidelink control channel (PSCCH) information, physical sidelink shared channel (PSSCH) information or physical sidelink feedback channel (PSFCH) information.

21. The method according to claim 20, wherein all of the time allocated to the second terminal device is all used to send the channel information, and the method further comprises:
in a case where in the time allocated to the second terminal device, there is first remaining time during which the channel information is not sent, repeatedly sending the channel information in the first remaining time;
or,
in a case where in the time allocated to the second terminal device, there is second remaining time during which the channel information is not sent, and the time allocated to the second terminal device comprises the last time unit in the COT, stopping sending the channel information in the second remaining time.

22. The method according to claim 20, wherein part of the time allocated to the second terminal device is used to send channel information, and the method further comprises:
in a case where in the part of the time used to send channel information, there is third remaining time during which the channel information is not sent, sending extended cyclic prefix information in the third remaining time.

23. The method according to claim 20, wherein the method further comprises:
in a case where there is PSFCH information sending time for the second terminal device in a second time period of the COT, sending the PSFCH information in the PSFCH information sending time;
wherein the second time period is time used for the first terminal device, or is a slot allocated to other second terminal devices except the second terminal device.

24-25. (canceled)

26. A first terminal device, comprising:
a processor; and
a memory storing instructions executable by the processor,
wherein the processor is configured to:
send COT time allocation indication information to a second terminal device, wherein the COT time allocation indication information is used to indicate time allocated to the second terminal device in the COT, and the COT initiated by the first terminal device is shared by the second terminal device.

27. A first terminal device, comprising:
a processor; and
a memory storing instructions executable by the processor,
wherein the processor is configured to perform the method according to claim 11.

28-31. (canceled)
